(19) United States
(12) Patent Application Publication
(10) Pub. No.: US 2018/0032874 A1
(43) Pub. Date: Feb. 1, 2018

(54) DOCUMENT ANALYSIS SYSTEM THAT USES PROCESS MINING TECHNIQUES TO CLASSIFY CONVERSATIONS

(71) Applicant: CA, Inc., New York, NY (US)

(72) Inventors: David Sánchez Charles, Barcelona (ES); Jaume Ferrarons Llagostera, Barcelona (ES); Victor Muntés Mulero, Barcelona (ES)

(73) Assignee: CA, Inc., New York, NY (US)

(21) Appl. No.: 15/224,357

(22) Filed: Jul. 29, 2016

(51) Int. Cl. G06N 5/02; G06F 17/28; G06F 9/50

(52) U.S. Cl. CPC G06N 5/02; G06F 9/5011; G06F 17/28

(57) ABSTRACT

A method includes performing, by a processor: receiving a first document, the first document comprising a first plurality of sub-documents that are related to one another in a first time sequence; converting the first plurality of sub-documents to a vector format to generate a vectorized document that encodes a probability distribution of words in the document and transition probabilities between words; detecting a plurality of topics within the vectorized document, the plurality of topics being related to one another in the first time sequence; applying a process discovery algorithm to the plurality of topics to generate a model that is representative of relationships between the plurality of topics; receiving a second document containing subject matter related to a course of action, the second document comprising a second plurality of sub-documents that are related to one another in a second time sequence; using the model to generate a classification for the second document; and adjusting the course of action based on the classification for the second document.

### BACKGROUND

The present disclosure relates to computer systems, and, in particular, to methods, systems, and computer program products for classifying conversations based on automatic detection of topics and topic evolution over time.

Some textual documents, such as tickets in customer support systems, evolve over time. A document, such as a help request ticket, may comprise a sequence of messages exchanged between a customer and one or more support engineers. The complete sequence of these messages contains all of the information about the ticket, but they are typically generated sequentially over a period of time, which may range from a day to several months depending on the complexity of the issue to be solved. The first messages usually provide a general description of the problem. The content of the messages may, however, evolve throughout the chain of messages and delve into other topics of discussion related to the initial issue, concepts that may be relevant to addressing the issue, etc. Thus, a document, such as a trouble ticket may be routed to a particular subject matter expert based on the initial messages from a customer. But as more messages are exchanged, it may become clear that the original assignment of the document to a particular subject matter expert for resolution of a problem was in error because the classification of the subject matter describing the problem was incorrect. Moreover, when the conversation between the customer and the support team ends, the ticket may be enriched with extra information about the conversation outcomes, such as the product causing the issue, the type of fix needed, the proposed solution, the estimated time to resolve the problem, and/or a satisfaction level of the customer with the support team. Because this historical information is not readily accessible to support engineers, it may be difficult to predict whether a ticket is likely to be escalated to a higher level of urgency, such as a formal complaint, and to determine when to allocate more resources to a ticket to avoid such an escalation.

### SUMMARY

In some embodiments of the inventive subject matter, a method comprises performing, performing by a processor: receiving a first document, the first document comprising a first plurality of sub-documents that are related to one another in a first time sequence; converting the first plurality of sub-documents to a vector format to generate a vectorized document that encodes a probability distribution of words in the document and transition probabilities between words; detecting a plurality of topics within the vectorized document, the plurality of topics being related to one another in the first time sequence; applying a process discovery algorithm to the plurality of topics to generate a model that is representative of relationships between the plurality of topics; receiving a second document containing subject matter related to a course of action, the second document comprising a second plurality of sub-documents that are related to one another in a second time sequence; using the model to generate a classification for the second document; and adjusting the course of action based on the classification for the second document.

In other embodiments of the inventive subject matter, a system comprises a processor and a memory coupled to the processor and comprising computer readable program code embodied in the memory that is executable by the processor to perform: receiving a first document containing subject matter related to a course of action, the first document comprising a plurality of sub-documents that are related to one another in a time sequence; using a model comprising a topic sequence derived from a second document to generate a classification for the first document; and adjusting the course of action based on the classification for the first document.

In further embodiments of the inventive subject matter, a computer program product comprises a tangible computer readable storage medium comprising computer readable program code embodied in the medium that is executable by a processor to perform: receiving a first document containing subject matter related to a course of action, the first document comprising a plurality of sub-documents that are related to one another in a time sequence; using a plurality of models comprising a plurality of topic sequences, respectively, derived from a plurality of second documents to generate a classification for the first document; using a plurality of models comprising a plurality of topic sequences, respectively, derived from a plurality of second documents to generate a classification for the first document; and adjusting the course of action based on the classification for the first document.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including a document analysis server for classifying conversations using process mining techniques in accordance with some embodiments of the inventive subject matter;

FIG. 2 illustrates a data processing system that may be used to implement the document analysis server of FIG. 1 in accordance with some embodiments of the inventive subject matter;

FIG. 3 is a block diagram that illustrates a software/hardware architecture for use in an a document analysis server for classifying conversations using process mining techniques in accordance with some embodiments of the inventive subject matter;

FIG. 4 is a flowchart diagram that illustrates operations for classifying conversations using process mining techniques in accordance with some embodiments of the inventive subject matter;

FIGS. 5 and 6 are block diagrams that illustrate document vectorization in accordance with some embodiments of the inventive subject matter;

FIG. 7 is a block diagram that illustrates topic detection within one or more documents in accordance with some embodiments of the inventive subject matter;

FIG. 8 is a block diagram that illustrates model generation for ordered lists of topics using process mining techniques based on document topics in accordance with some embodiments of the inventive subject matter;

FIG. 9 is a block diagram that illustrates classification of a document based on one or more models in accordance with some embodiments of the inventive subject matter; and

FIG. 10 is a block diagram that illustrates a model representing a sequence of topics detected in one or more documents in accordance with some embodiments of the inventive subject matter.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it is not limited to, a hardware element, firmware component, and/or software component. A data processing system may be configured with one or more data processing facilities.

As used herein, data are raw, unorganized facts that need to be processed. Data can be something simple and seemingly random and useless until it is organized. When data are processed, organized, structured or presented in a given context so as to make it useful, it is called content or information. Examples of content or information include, but are not limited to, word processing files, slide presentation program files, spreadsheet files, video files, audio files, picture files, and document exchange files.

Some embodiments of the inventive subject matter stem from a realization that in an information exchange between two entities the conversation represented by the information exchange can be recorded in a document and classified based on one or more models. By determining the model that best describes the evolution of topics in a conversation, a course of action may be taken to ensure that the proper personnel and/or computing resources are engaged or acquired to resolve the issues raised in the conversation. For example, a conversation may include topics related to various technical problems as well as sales questions. The conversation may be classified with 75% confidence as being a technical conversation related to connectivity problems and with 25% confidence as being a sales conversation. Accordingly, a connectivity expert may be brought into the conversation and a party may be provided with an option to speak to a sales representative. Such classifications may allow an enterprise to better service customers when responding to their sales inquiries, help requests, complaints, and the like to ensure the proper resources are brought to bear to meet customer needs before customers become frustrated or upset and seek to escalate the urgency of a conversation by getting a supervisor involved, filing a formal complaint, or the like.

According to some embodiments of the inventive concept, a document can be based on multiple messages, which may be considered sub-documents of a sequence of messages. One or more models can be created by analyzing messages from previous documents and representing them as a graph. Topics may be automatically discovered using, for example, semantic-aware text projections to a multidimensional space. FIG. 10, for example, illustrates an exemplary model. Topics A, B, C, D and E were discovered through a semantic-aware clustering method, and are represented in the graph as nodes. A connection between nodes “Topic A” and “Topic C” represents that, at some point, a message with topic A was followed by a message with topic C. This formalism may allow for representation of iterative processes, which may be useful to model trial-and-error approaches to the resolution of tickets. This is shown, for example, in the loop structure of Topics A, C (or E) and D in FIG. 10. By way of example, messages related to Topic A could be the customer uploading a log file, Topic C (or E) could be messages involving the support engineer asking for more information or proposing a fix, and Topic B could be messages related the validity of the proposed fix. This section of the process could be repeated until a fix is found.

Various types of models can be generated in accordance with different embodiments of the inventive subject matter. For example, it may be desirable to build models that classify a conversation in one of two binary categories, such as those conversations likely to require escalation to a manager, supervisor, expert, or other authority, and those conversations that are likely to be resolved without escalation. Other models may be built that can be used to classify conversations with a quantitative measure of the likelihood the conversation belongs to the category. For example, various models may be applied to a document representing a conversation to determine that the conversation is a help desk conversation with 50% confidence, a sales conversation with 48% confidence, and a billing conversation with 2% confidence.

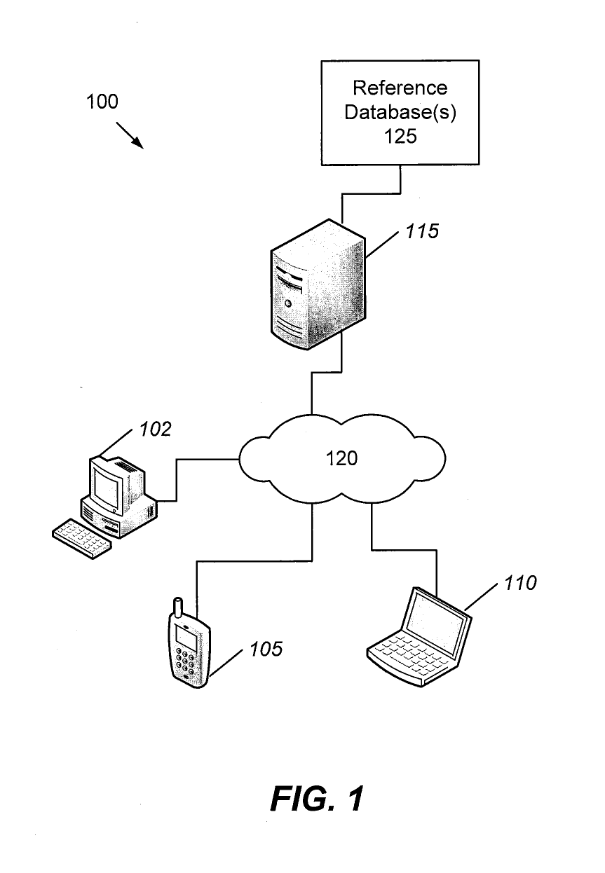

Referring to FIG. 1, a communication network including a document analysis server for classifying conversations using process mining techniques, in accordance with some embodiments of the inventive subject matter, comprises end user devices 102, 105, and 110 that are coupled to a document analysis server 115 via a network 120. The network 120 may be a global network, such as the Internet or other publicly accessible network. Various elements of the network 120 may be interconnected by a wide area network, a local area network, an Intranet, and/or other private network, which may not be accessible by the general public. Thus, the communication network 120 may represent a combination of public and private networks or a virtual private network (VPN). The network 120 may be a wireless network, a wireline network, or may be a combination of both wireless and wireline networks. The end user devices 102, 105, 110 may represent wired and/or wireless devices that include one or more applications that allow an end user to access the document analysis server 115 to classify the conversation subject matter of one or more documents in accordance with some embodiments of the inventive subject matter. Moreover, end user devices or terminals may be connected directly to the document analysis server 115 without going through the network 120 in other embodiments of the inventive subject matter. It will be appreciated that in accordance with various embodiments of the inventive subject matter, the document analysis server 115 may be implemented as a single server, separate servers, or a network of servers either co-located in a server farm, for example, or located in different geographic regions.

The document analysis server 115 may be connected to one or more information repositories represented as reference database(s) 125. The reference database(s) 125 may include other documents and information that can be used to facilitate the classification of the conversation subject matter of a document that evolves over time.

As shown in FIG. 1, some embodiments according to the inventive subject matter can operate in a logically separated client side/server side-computing environment, sometimes referred to hereinafter as a client/server environment. The client/server environment is a computational architecture that involves a client process (i.e., client devices 102, 105 and 110) requesting service from a server process (i.e., document analysis server 115). In general, the client/server environment maintains a distinction between processes, although client and server processes may operate on different machines or on the same machine. Accordingly, the client and server sides of the client/server environment are referred to as being logically separated. Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

The clients and servers can communicate using a standard communications mode, such as Hypertext Transport Protocol (HTTP), SOAP, XML-RPC, and/or WSDL. According to the HTTP request-response communications model, HTTP requests are sent from the client to the server and HTTP responses are sent from the server to the client in response to an HTTP request. In operation, the server waits for a client to open a connection and to request information, such as a Web page. In response, the server sends a copy of the requested information to the client, closes the connection to the client, and waits for the next connection. It will be understood that the server can respond to requests from more than one client.

Although FIG. 1 illustrates an exemplary communication network including a document analysis server for classifying conversations using process mining techniques, it will be understood that embodiments of the inventive subject matter are not limited to such configurations, but are intended to encompass any configuration capable of carrying out the operations described herein.

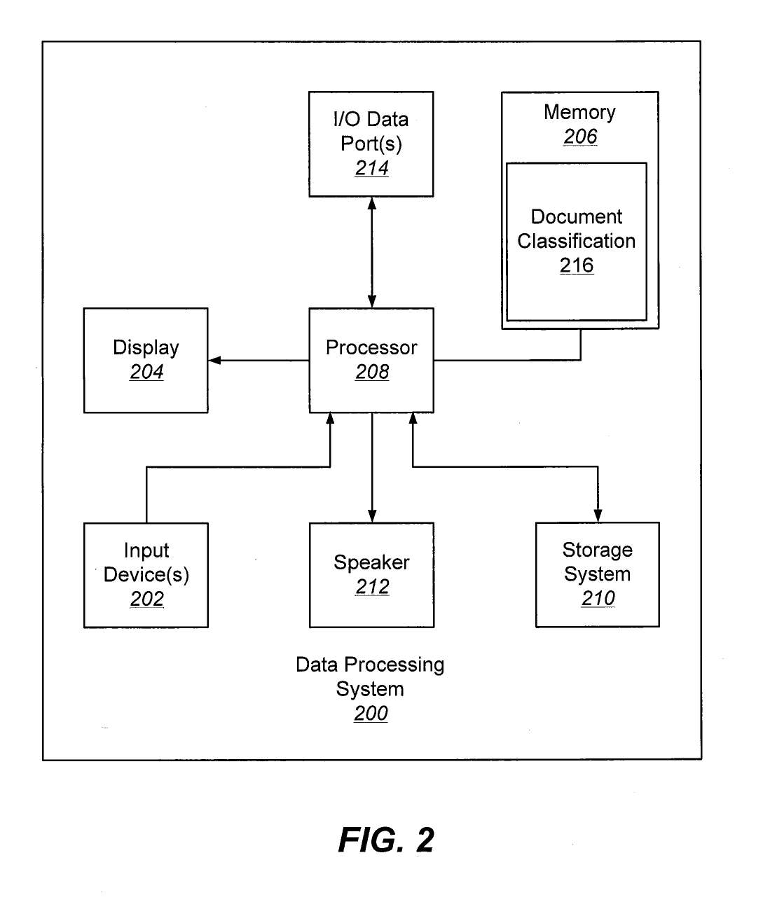

Referring now to FIG. 2, a data processing system 200 that may be used to implement the document analysis server 115 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a document classification module 216 that may provide functionality that may include, but is not limited to, facilitating the classification of conversations using process mining techniques.

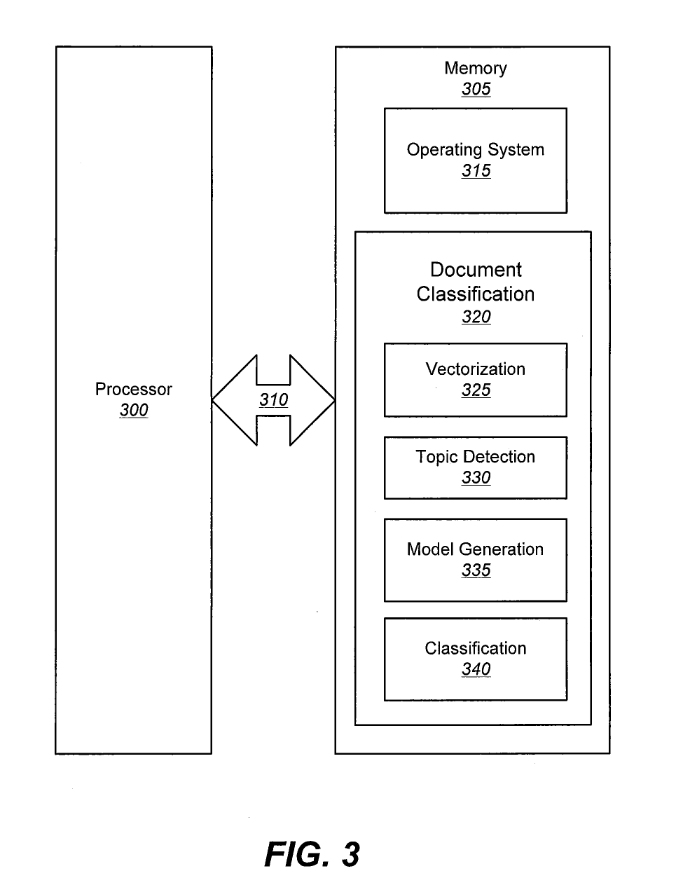

FIG. 3 illustrates a processor 300 and memory 305 that may be used in embodiments of data processing systems, such as the document analysis server 115 of FIG. 1 and the data processing system 200 of FIG. 2, respectively, for facilitating the classification of conversations using process mining techniques in accordance with some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for classifying conversations using process mining techniques in accordance with some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain two or more categories of software and/or data: an operating system 315 and a document classification module 320. In particular, the operating system 315 may manage the data processing system's software and/or hardware resources and may coordinate execution of programs by the processor 300. The document classification module 320 may comprise a vectorization module 325, a topic detection module 330, a model generation module 335, and a classification module 340.

The vectorization module 325 may be configured to receive a document that comprises a plurality of sub-documents that are related to one another in a time sequence. Examples of such documents may include, but are not limited to, trouble tickets exchanged between a customer and a technical specialist, messages exchanged between a patient and a medical professional, blog entries or comments on a Web page, and the like. The vectorization module 325 may be further configured to convert the documents to a vector format to generate a vectorized document. In accordance with various embodiments of the inventive subject matter, the vectorization module 325 may use vectorization algorithms, including, but not limited to, natural language vectorization algorithms, such as Doc2Vec, Latent Dirichlet Allocation (LDA), and/or Term Frequency-Inverse Document Frequency (TF-IDF) to generate the vectorized document. Doc2Vec is an extension of Word2vec, which is a group of related models that are used to produce word embeddings. These vectorization algorithms may encode the probability distribution of words in the document along with the transition probabilities between words. The vector of a message is the likelihood of a message being related to a particular topic with similar messages being projected to relatively close to each other in multi-dimensional space.

The topic detection module 330 may be configured to detect one or more topics within the vectorized document. Vector points that are relatively close to each other may represent messages with similar meaning, i.e., related to a similar topic due to the similarity of words used and/or discerned context. These groups of vector points may define the various topics contained within the message sequence. Various clustering methods can be used to detect the vector point clusters including, but not limited to, the K-means algorithm, the K-medoids variant algorithm, and the Density-spaced Spatial Clustering of Applications with Noise (DBSCAN) algorithm. Based on the clustering, a sequence of topics may be derived from the sequence of messages. Defining topics using such a clustering methodology may allow a determination of how similar two topics are and/or how close a message is to various topics. For example, using the average distance to a cluster, the silhouette score, and/or K-medoid techniques provide a measure of the distance between messages (represented as points in space) to a topic (represented as a cluster of points).

The model generation module 335 may be configured to generate one or more models that is representative of the relationships (e.g., ordering) between the topics detected using the topic detection module 330. Various process discovery algorithms or process mining methodologies may be used including, but not limited to, a fuzzy miner algorithm, a heuristic miner algorithm, an inductive miner algorithm, and/or a genetic process miner algorithm. Such techniques may analyze the order of activities in the topic sequences and build a process model that explains this ordering and other execution rules, such as concurrency, iterative processes, and inclusive choices.

Embedding the messages into real-valued vectors using the vectorization module 325, automatic detection of topics using the topic detection module 330, and model generation based on the detected topics using the model generation module 335 may be performed on a repository of stored messages. The models that are generated using this process, according to some embodiments of the inventive subject matter, may be used to classify newly generated sequences of messages.

The classification module 340 may be configured to receive the sequence of topics output from the topic detection module 330 for a new sequence of messages along with the models previously generated by the model generation module 335 for other message sequences. Using the topic sequence along with the models, a determination is made of which paths in the various models best describe the new conversation. The conversation may then be classified according to which model best represents the topic sequence of the conversation. In accordance with some embodiments of the inventive subject matter, trace alignment algorithms and techniques can be used to find the most similar paths between the conversation topic sequence and the various models.

Although FIG. 3 illustrates hardware/software architectures that may be used in data processing systems, such as the document analysis server 115 of FIG. 1 and the data processing system 200 of FIG. 2, respectively, for facilitating the classification of conversations using process mining techniques in accordance with some embodiments of the inventive subject matter, it will be understood that the present invention is not limited to such a configuration but is intended to encompass any configuration capable of carrying out operations described herein.

Computer program code for carrying out operations of data processing systems discussed above with respect to FIGS. 1-3 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the document analysis server 115 of FIG. 1, the data processing system 200 of FIG. 2, and the hardware/software architecture of FIG. 3, may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

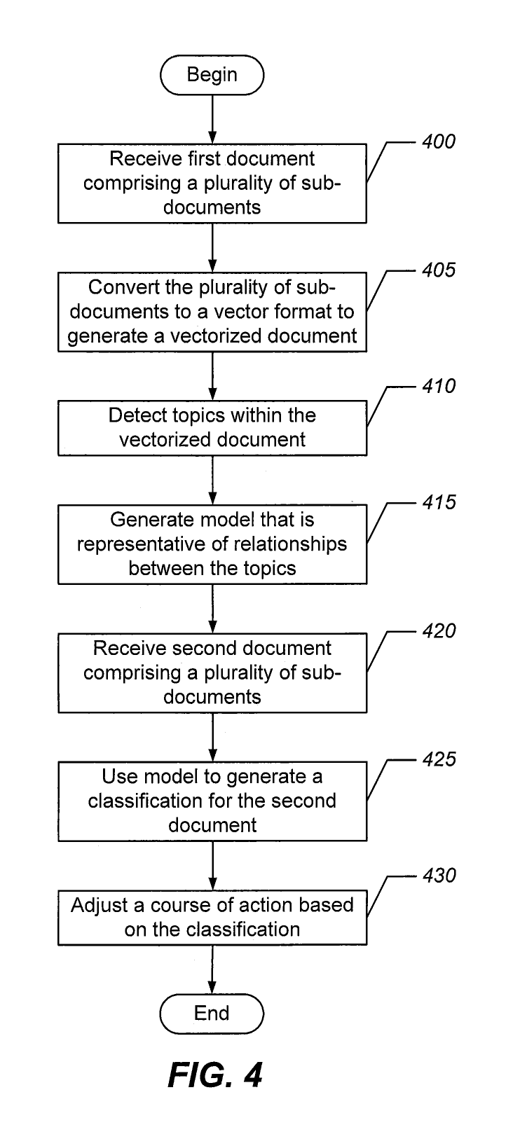

The data processing apparatus of FIGS. 1-3 may be used to facilitate the classification of conversations using process mining techniques according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 206 coupled to the processor 208 and the memory 305 coupled to the processor 300 include computer readable program code that, when executed by the respective processors, causes the respective processors to perform operations including one or more of the operations described herein with respect to FIGS. 4-9.

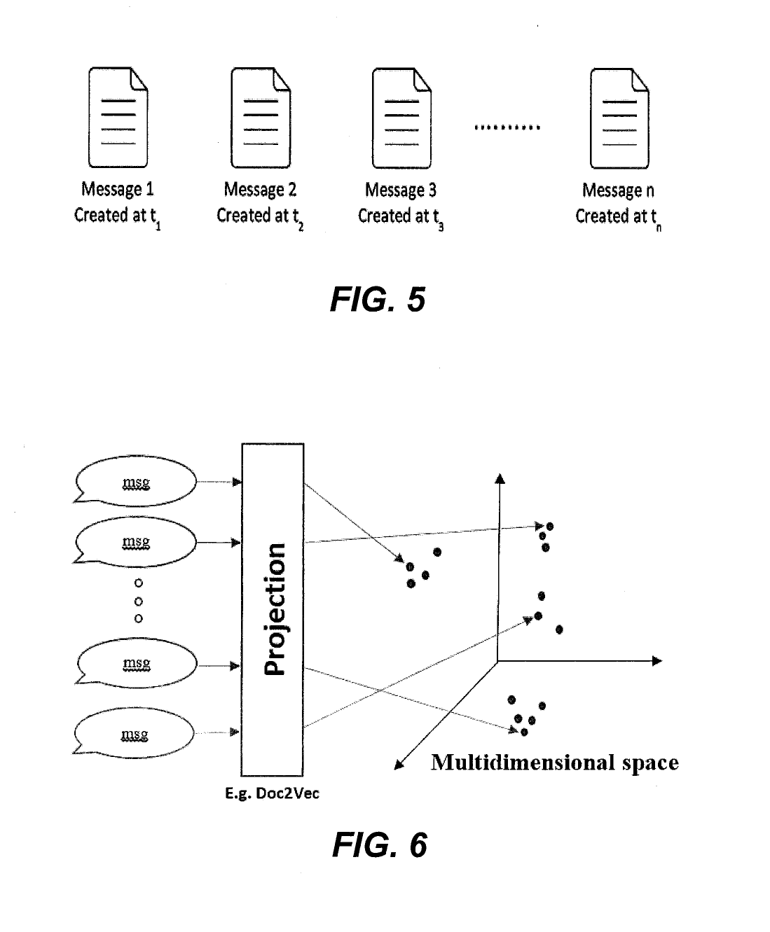

FIG. 4 is a flowchart that illustrates operations for facilitating the classification of conversations using process mining techniques in accordance with some embodiments of the inventive subject matter. Operations begin at block 400 where the vectorization module 325 receives one or more documents each comprising a plurality of sub-documents. This is illustrated, for example, in FIG. 5 where a document comprising a plurality of messages—Message 1, Message 2, . . . Message n—is received in a time sequence represented by t₁, t₂, . . . tₙ. At block 405, the vectorization module 325 converts the sub-documents to a vector format to generate a vectorized document. The vectorization process is illustrated in FIG. 6 where the various messages (e.g., sub-documents) from one or more documents are shown as projected into multidimensional space. Example vectorization techniques may include, but are not limited to, TF-IDF, Doc2Vec, and LDA. TF-IDF is a technique that computes a score for each word in the message such that it is in direct proportion to the frequency of the word in the message, and in reverse proportion to the frequency of the word across messages. Doc2Vec is a technique that maps words and documents to a vector space by placing entities with similar context very close in the space. The LDA technique finds groups of words that are usually found together (indicating they might define a topic), such that the vector of a message is the likelihood of the message talking about each topic.

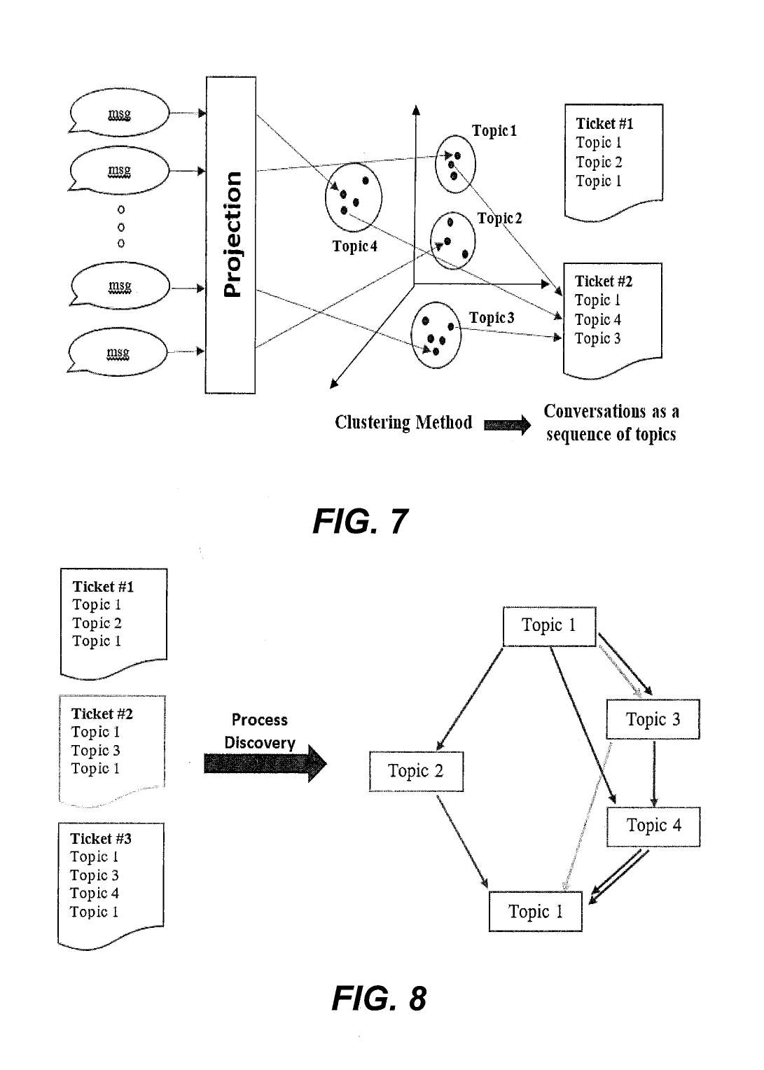

Once the messages have been mapped into multidimensional space through the vectorization operation, the topic detection module 330 may detect one or more topics within the vectorized document at block 410. The detection of topics from the vectorized messages is illustrated, for example, in FIG. 7. The groups of vector points may define the various topics contained within the message sequence, which may be detected using, for example, a clustering methodology. Various clustering methods can be used to detect the vector point clusters including, but not limited to, the K-means algorithm, the K-medoids variant algorithm, and the DBSCAN algorithm. A sequence of topics may be derived from the sequence of messages using clustering.

At block 415, the model generation module 335 may generate one or more models that is representative of the relationships (e.g., ordering) between the topics detected using the topic detection module 330. This is illustrated in FIG. 8, for example, where the model represents Tickets #1, #2, and #3 along with the sequence Topic 1-Topic 4-Topic 1, which is not included in any ticket in the documents that were vectorized and topics detected. Various process discovery algorithms or process mining methodologies may be used in generating a model including, but not limited to, a fuzzy miner algorithm, a heuristic miner algorithm, an inductive miner algorithm, and/or a genetic process miner algorithm.

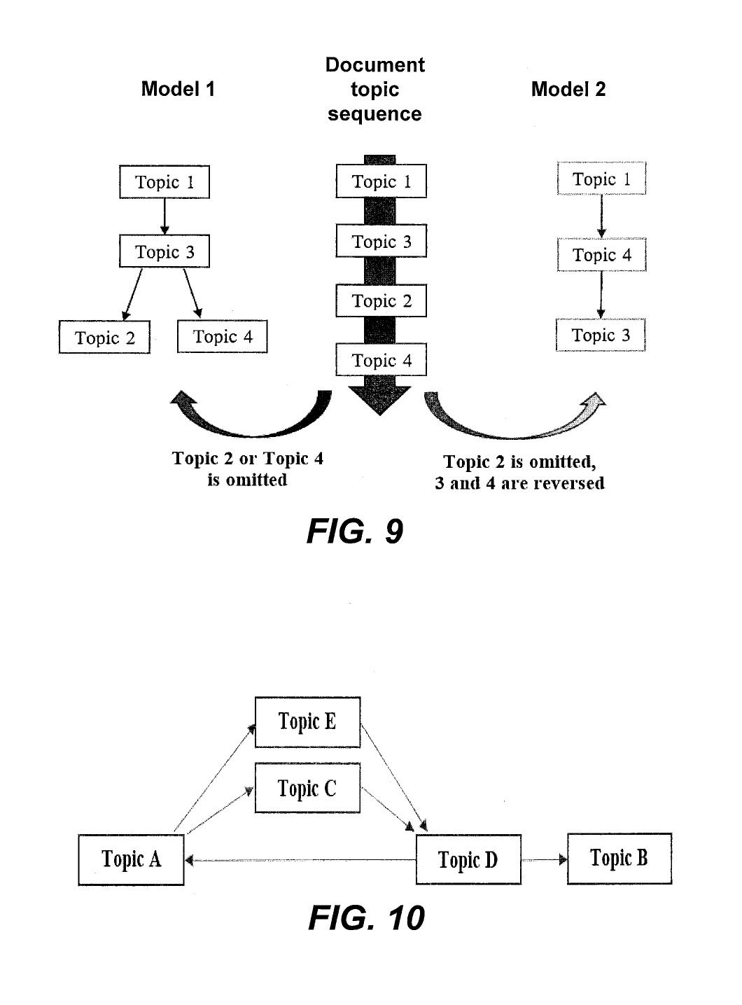

The operations of blocks 400, 405, 410, and 415 may be performed on a repository of stored messages. The models that are generated using these operations, according to some embodiments of the inventive subject matter, may be used to classify newly generated sequences of messages. Accordingly, at block 420, a second document may be received that comprises a plurality of sub-documents. The classification module 340 may classify the second document using the one or more models that were generated at block 415 to determine which model best represents the conversation (e.g., the sequence of messages) contained in the second document. For example, the second document can be vectorized using the vectorization module 325 and the topics detected from the vector projections of the sub-documents (e.g., the sequence of messages) using the topic detection module 330. The conversation contained within the second document may then be classified by comparing the topic sequence of the second document with the various model(s) that have previously been generated. As shown in the example of FIG. 9, a new document topic sequence may be compared with two previously generated models—Model 1 and Model 2. Model 1 differs from the new document topic sequence in that Topic 2 or Topic 4 is omitted. Model 2 differs from the new document topic sequence in that Topic 2 is omitted and Topics 3 and 4 are reversed. Which model is best representative of the new document topic sequence may be based on costs assigned when using a trace alignment technique for finding the most similar paths in sequences of topics. Trace alignment is a process mining technique to measure how likely a sequence of topics for a new document is explained by a model. This measurement may be computed by considering the topics that are skipped and/or added in the model to find a path in the model that is equal to the sequence of topics in the new document. In some embodiments, a cost may be defined for skipping or adding a topic, and a cost for substituting a topic for another. Then, the minimum-cost path (also known as the cheapest path) in the model may be determined by comparing the model to the topic sequence of the new document. As a result, the closest path in the model to the conversation contained within the new document may be obtained and a score (e.g., the cost) measuring how far apart the two paths are may be generated. Because topics may be represented in a vector space, a difference between topics can be easily defined as the usual Euclidean distance in a vector space.

To classify a textual conversation, the top N cheapest paths among all models may be considered, where N is a manually-defined integer that sets the granularity of the resulting fuzzy classifier. When N is 1, the conversation contained in a new document may be classified as the category of the model that best describes the conversation. If N>1, the output may be a fuzzy classification. TABLE 1 shown below illustrates an example in which a sequence of topics for a new document is compared to three different models and the four cheapest paths for each model are identified.

TABLE 1

| | | | | |
|---|---|---|---|---|
| Model 1 | 0.45 | 0.35 | 0.2 | 0.05 |
| Model 2 | 0.32 | 0.27 | 0.1 | 0.07 |
| Model 3 | 0.3 | 0.3 | 0.3 | 0.03 |

If N equal to 1, then the category of the topic sequence would be Model 3. This is because of the twelve paths evaluated across the three different models, Model 3 has the path that has least cost associated therewith (0.03), i.e., the path in Model 3 having a score 0.03 may have the fewest topics skipped, added, or substituted compared to the topic sequence being evaluated as compared to the other eleven paths being considered across the three models. If N=6, then there are better descriptions of the topic sequence, which are highlighted in bold in TABLE 1. In this case, the classification would be that the category of the topic sequence is 2/6 for Model 1, 3/6 for Model 2 and 1/6 for Model 3. These may be viewed as confidence levels that the topic sequence belongs to a particular category represented by a model. In this example, the confidence level is 2/6 that the topic sequence is best represented by Model 1, 3/6 that the topic sequence is best represented by Model 2, and 1/6 that the topic sequence is best represented by Model 3. By increasing the value of N, models that do not fit the topic sequence globally are penalized.

The above-described method is an N-Nearest Neighbor method. It finds the closest paths and classifies the topic sequence as the category of the majority. But other methods could be used to classify the sequence of topics using the data from TABLE 1 in accordance with various embodiments of the inventive subject matter. For example, a neural network may be trained that predicts the real category given these 12 numbers data points.

Based on the classification of the topics in a document, the classification module 340 may trigger an adjustment in a course of action at block 430. For example, in some embodiments, based on the classification a conversation in a document, the classification module 340 may determine a destination location for electronically communicating the document. This destination may correspond to an entity or person who may be best equipped to address issues raised in the document or who may have interest in the subject matter of the document. In some embodiments, adjusting the course of action may involve allocating computing resources based on the classification of the conversation. For example, the document topics may pertain to an architectural discussion for a computing system, trouble tickets generated due to hardware or software bugs, or the like. The classification module 340 may classify the document as pertaining to hardware and/or software upgrades or modifications. Thus, computing resources may be allocated according to the classification of the conversation. In other embodiments, allocation of computing resources may include restraints that certain servers and/or network equipment only use certain resources, time of day/week/month/year restrictions on when certain resources can be used, and the like.

Embodiments of the inventive subject matter may be used in a variety of applications. For example, a document comprising a sequence of trouble tickets between a technical specialist and a customer may be classified as pertaining to a particular field and be forwarded to a subject matter expert based on an analysis of the initial trouble tickets. In other embodiments, documents can be retrieved and provided to a technical specialist in advance anticipating that future trouble ticket messages may be directed to the subject matter contained in these documents.

In a health care setting, a triage medical professional may record various symptoms of a patient along with the patient's vitals. These data may be considered sub-documents that are part of an overall document addressing a patient's health condition. Based on these initial data, the document may be classified in such a category that indicates that the patient will often complain of one or more additional symptoms and/or may be diagnosed in a particular manner. Thus, the document may be electronically communicated to a particular specialist and/or department in the health care facility for additional analysis or treatment.

In a computer system development and/or support setting, embodiments of the inventive subject matter may complement bug tracking tools to assist in their classification and/or resolution. For example, based on a discussion among software developers describing a particular bug in the system, the discussion may be classified as pertaining to bugs that are moderate in severity and generally takes 2-3 days to resolve. In some embodiments, predictions can be made regarding typical sources of the bug or techniques to try to further pinpoint the cause of the bug.

In a customer service setting, embodiments of the inventive subject matter may be used to monitor the exchange of messages between a customer and a customer support representative. The document containing the conversation can be classified as a conversation that typically involves escalation, i.e., the inclusion of some type of supervisory or managerial authority. If the classification category is one that indicates the customer is likely to be dissatisfied or frustrated, the document containing the exchange can be electronically communicated to a supervisor allowing the supervisor to intervene to address the customer's concerns.

In a sales setting, embodiments of the inventive subject matter may be used to monitor the exchange of messages between a customer and a sales representative. A classification may be generated that indicates the customer is likely to make a purchase based on the exchange of messages thus far. If it appears that a sale is unlikely based on the classification, then the sales representative may change the terms of the offer and/or offer a different product or service for which the customer may be more receptive.

Further Definitions and Embodiments:

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
performing by a processor:
receiving a first document, the first document comprising a first plurality of sub-documents that are related to one another in a first time sequence;
converting the first plurality of sub-documents to a vector format to generate a vectorized document that encodes a probability distribution of words in the document and transition probabilities between words;
detecting a plurality of topics within the vectorized document, the plurality of topics being related to one another in the first time sequence;
applying a process discovery algorithm to the plurality of topics to generate a model that is representative of relationships between the plurality of topics;
receiving a second document containing subject matter related to a course of action, the second document comprising a second plurality of sub-documents that are related to one another in a second time sequence;
using the model to generate a classification for the second document; and
adjusting the course of action based on the classification for the second document.

2. The method of claim 1, wherein adjusting the course of action based on the classification for the second document comprises:
determining a destination for communication of the second document based on the classification for the second document; and
electronically communicating the second document to the destination.

3. The method of claim 1, wherein adjusting the course of action based on the classification for the second document comprises:
allocating computing resources based on the classification for the second document.

4. The method of claim 1, wherein converting the first plurality of sub-documents to the vector format comprises:
applying a Doc2Vec algorithm to the first document to generate the vectorized document.

5. The method of claim 1, wherein converting the first plurality of sub-documents to the vector format comprises:
applying a Latent Dirichlet Allocation (LDA) algorithm to the first document to generate the vectorized document.

6. The method of claim 1, wherein converting the first plurality of sub-documents to the vector format comprises:
applying a Term Frequency-Inverse Document Frequency (TF-IDF) algorithm to the first document to generate the vectorized document.

7. The method of claim 1, wherein detecting the plurality of topics within the vectorized document comprises:
applying a K-means algorithm to the vectorized document to detect a plurality of vector point clusters.

8. The method of claim 1, wherein detecting the plurality of topics within the vectorized document comprises:
applying a K-medoids variant algorithm to the vectorized document to detect a plurality of vector point clusters.

9. The method of claim 1, wherein detecting the plurality of topics within the vectorized document comprises:
applying a Density-based Spatial Clustering of Applications with Noise (DBSCAN) algorithm to the vectorized document to detect a plurality of vector point clusters.

10. The method of claim 1, wherein applying the process discovery algorithm to the plurality of topics to generate the model comprises:
applying one of a fuzzy miner algorithm, heuristic miner algorithm, inductive miner algorithm, and genetic process miner algorithm to the plurality of topics to generate the model.

11. The method of claim 1, wherein the plurality of topics is a first plurality of topics and wherein using the model to generate the classification for the second document comprises:
applying a trace alignment algorithm to the model and the second document to generate a quantitative measure of a difference between the model and a second plurality of topics obtained from the second document.

12. The method of claim 11, wherein adjusting the course of action based on the classification for the second document comprises:
adjusting the course of action by determining a destination for communication of the second document based on the quantitative measure; and
electronically communicating the second document to the destination.

13. A system, comprising:
a processor; and
a memory coupled to the processor and comprising computer readable program code embodied in the memory that is executable by the processor to perform:
receiving a first document containing subject matter related to a course of action, the first document comprising a plurality of sub-documents that are related to one another in a time sequence;
using a model comprising a topic sequence derived from a second document to generate a classification for the first document; and
adjusting the course of action based on the classification for the first document.

14. The system of claim 13, wherein adjusting the course of action based on the classification for the first document comprises:
determining a destination for communication of the first document based on the classification for the first document; and
electronically communicating the first document to the destination.

15. The system of claim 13, wherein adjusting the course of action based on the classification for the first document comprises:
allocating computing resources based on the classification for the first document.

16. The system of claim 13, wherein using the model comprising the topic sequence derived from the second document to generate the classification for the first document comprises:
applying a trace alignment algorithm to the model and the second document to generate a quantitative measure of a difference between the model and the second plurality of topics obtained from the second document.

17. A computer program product comprising:
a tangible computer readable storage medium comprising computer readable program code embodied in the medium that is executable by a processor to perform:
receiving a first document containing subject matter related to a course of action, the first document comprising a plurality of sub-documents that are related to one another in a time sequence;
using a plurality of models comprising a plurality of topic sequences, respectively, derived from a plurality of second documents to generate a classification for the first document; and
adjusting the course of action based on the classification for the first document.

18. The computer program product of claim 17, wherein the plurality of topics is a first plurality of topics and wherein using the model to generate the classification for the second document comprises:
applying a trace alignment algorithm to the plurality of models and the second document to generate a plurality of quantitative measures of differences between the plurality of models and a second plurality of topics obtained from the second document, respectively.

19. The computer program product of claim 18, wherein adjusting the course of action based on the classification for the second document comprises:
adjusting the course of action by determining a plurality of destinations for communication of the second document based on the plurality of quantitative measures; and
electronically communicating the second document to the plurality of destinations.

20. The computer program product of claim 17, wherein adjusting the course of action based on the classification for the first document comprises:
allocating computing resources based on the classification for the first document.
